(19) United States
(12) Patent Application Publication
(10) Pub. No.: US 2002/0028426 A1
(43) Pub. Date: Mar. 7, 2002

(54) Method and system for electronic post-secondary education planning including user feedback

(76) Inventor: Cynthia M. Pasant, Naperville, IL (US)

Correspondence Address: Leslie B. Wilson, CARDINAL LAW GROUP, Suite 2000, 1603 Orrington Ave., Evanston, IL, 60201, US

(21) Appl. No.: 09/945,533

(22) Filed: Aug. 30, 2001

Related U.S. Application Data
(60) Provisional application No. 60/229,886, filed on Sep. 1, 2000.

(51) Int. Cl. G09B 19/00

(52) U.S. Cl. 434/118

(57) ABSTRACT

The method and system for electronic post-secondary education planning including user feedback of the present invention provides a comprehensive post-secondary education planning Internet system linking to the various Internet locations that provide college, university, adult education and trade school information, structured so that users can step through the process of finding appropriate post-secondary education in an organized, logical sequence, in which the site's users rate the usefulness of the links to online information and in which the site's users suggest additional online links providing additional information.

### CROSS REFERENCE TO RELATED APPLICATION

This application claims priority from U.S. Provisional Application No. 60/229,886, filed Sep. 1, 2000.

### TECHNICAL FIELD

The present invention relates to counseling methods, particularly to counseling methods for post-secondary education planning using a global computer information network with links to online information and with a feedback system for users to rate the usefulness of links.

### BACKGROUND OF THE INVENTION

For students and their parents, the process of sorting through the various (and sometimes conflicting) elements of finding a college, university, adult education or trade school can be a struggle. There are various places on the Internet that can provide some assistance. None of them (due to the vast number of institutions and search criteria) can provide all the information needed to find the perfect fit in terms of background, financial assistance needed, grades and entrance scores, etc. In addition, the information is often presented in a disorganized, random sequence so that users are not able to follow efficient, logical steps.

Internet sites are also presented without any indication of what previous users have found useful. Links to other Internet sites may find sites that are useful or may be a waste of time. Users may find other Internet sites that offer information that may be of use to other users. Internet sites that ignore the expertise and experience of their users miss an opportunity to improve their sites for future users.

### SUMMARY OF THE INVENTION

One aspect of the present invention provides a comprehensive post-secondary education planning Internet site linking to the various Internet locations that provide college, university, adult education, and trade school information.

Another aspect of the present invention provides a comprehensive post-secondary education planning Internet system structured so that users can step through the process of finding appropriate post-secondary education in an organized, logical sequence, leading them through the process from A to Z.

Another aspect of the present invention provides a comprehensive post-secondary education planning Internet site in which the site's users rate the usefulness of the links to online information.

Another aspect of the present invention provides a comprehensive post-secondary education planning Internet site in which the site's users suggest additional online links providing additional information.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 shows the home page screen made in accordance with the present invention;

FIG. 2 shows the Home frame made in accordance with the present invention;

FIG. 3 shows the Plan of Attack frame made in accordance with the present invention;

FIGS. 4A & 4B show the Tips and Advice frame made in accordance with the present invention;

FIGS. 5A & 5B show the Financial Aid frame made in accordance with the present invention;

FIGS. 6A & 6B show the Applying frame made in accordance with the present invention;

FIG. 7 shows the Pretest Prep. frame made in accordance with the present invention;

FIG. 8 shows the College Search frame made in accordance with the present invention; and

FIG. 9 shows the overall organization made in accordance with the present invention.

### DESCRIPTION OF THE PREFERRED EMBODIMENT

The present invention provides a comprehensive post-secondary education planning Internet system linking to the various Internet locations that provide college, university, adult education and trade school information, structured so that users can step through the process of finding appropriate post-secondary education in an organized, logical sequence, in which the site's users rate the usefulness of the links to online information and in which the site's users suggest additional online links providing additional information.

The post-secondary education planning counseling method of the present invention presents a series of screens electronically over a global computer information network, such as the Internet. The method could also be applied over a local system, such as a LAN or Intranet. The opening screen is a home screen and screens on specific topics follow. The computer code used in practicing the method can be HTML or another computer language transportable over a global computer information network as will be appreciated by those skilled in the art.

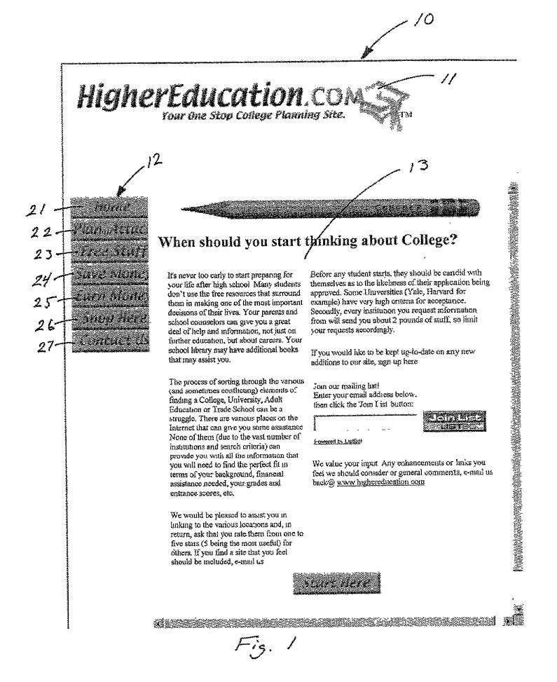

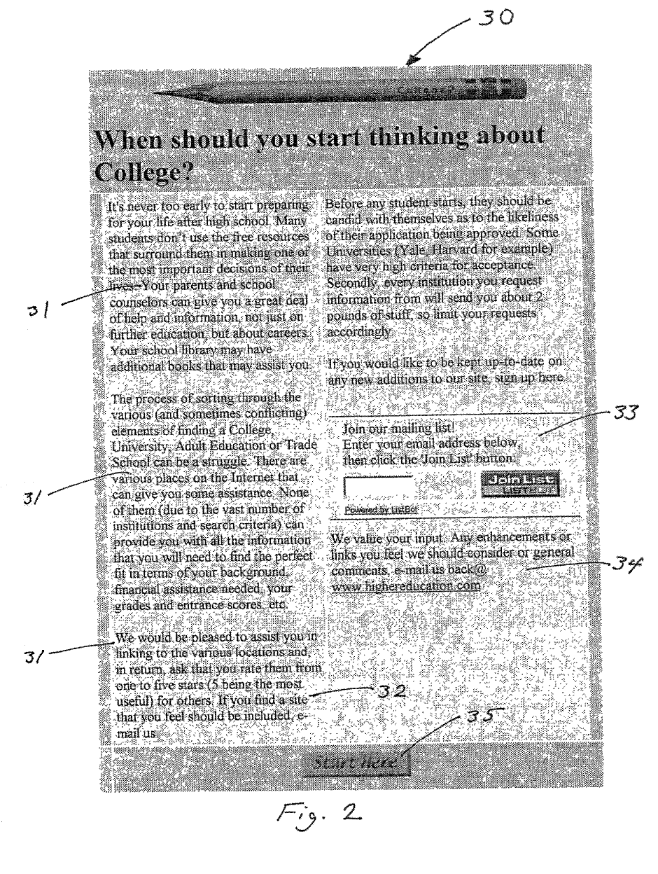

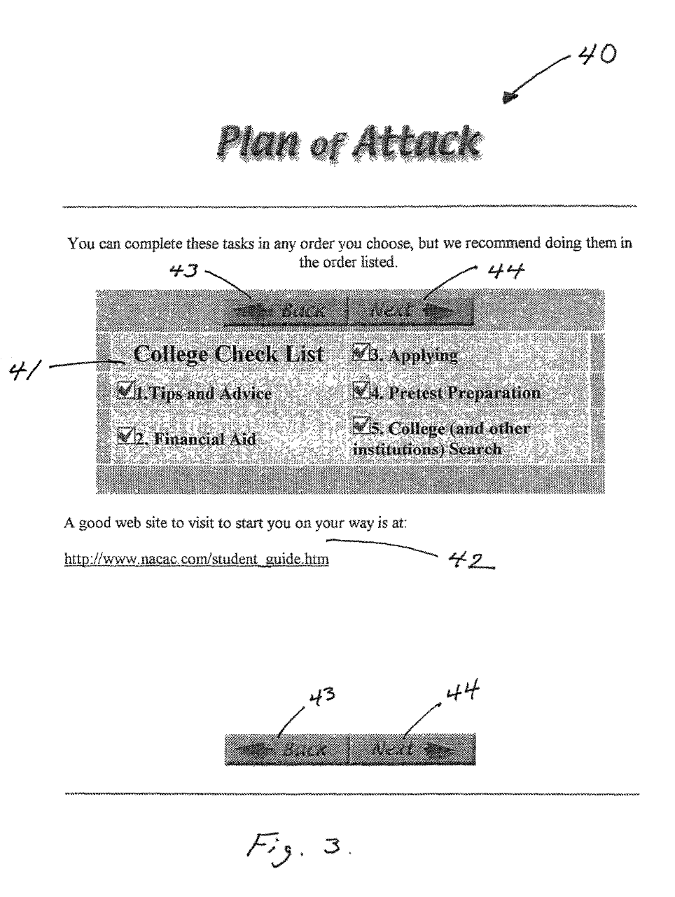

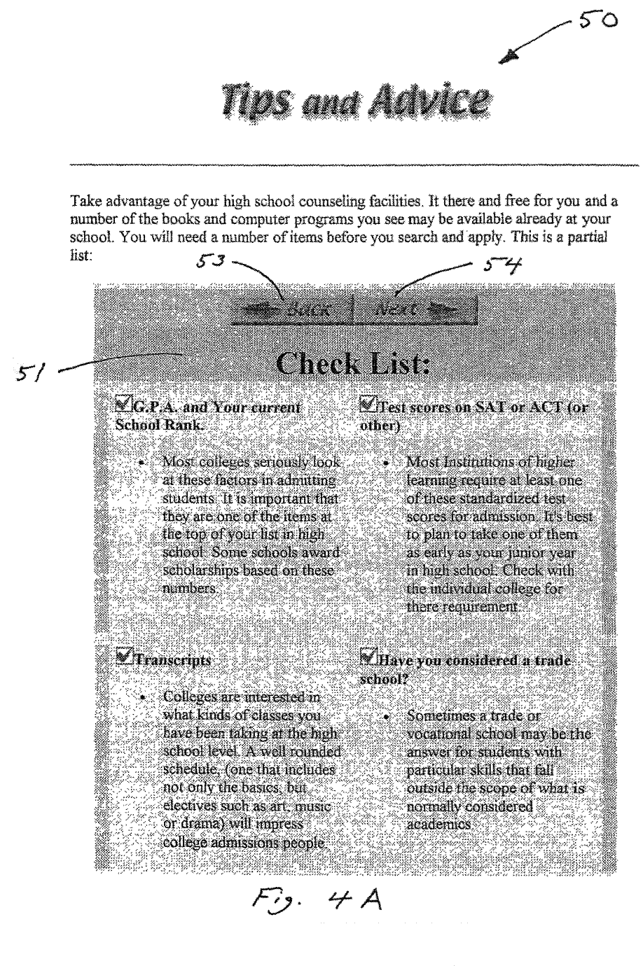

The computer screen 10 of FIG. 1 comprises a title frame 11, a button frame 12, and a subject frame 13. The title frame 11 and button frame 12 remain on the screen as the user navigates through the education planning system. The subject frame 13 changes as the user proceeds through the system: FIGS. 2-8 show subject frames for each individual subject of the system. The button frame 12 further comprises buttons with links to other screens providing items and information that would be of use to prospective students: Home button 21 which returns the user to Home frame 30 of FIG. 2; Plan of Attack button 22 which sends the user to Plan of Attack frame 40 of FIG. 3; Free Stuff button 23 with links to places supplying the user free goods and information; Save Money button 24 with links to sites that can save the user money; Earn Money button 25 with links to sites that can earn the user money; Shop Here button 26 with links to sites where the user can shop for school supplies like dorm room furniture, textbooks and clothing; and Contact Us button 27 with links for sending email to the host Web site.

Generally, each individual subject frame of FIGS. 2-8 provides guidance on a particular topic of post-secondary education planning. Navigation buttons couple the frames, so that the users can proceed through the sequence of frames in an orderly manner from A to Z.

Home frame 30 of FIG. 2 comprises problem discussion 31, feedback request 32, e-mail list sign-up 33, e-mail link 34, and start here button 35. The problem discussion 31 describes generally the problem of preparing for post-secondary education and the solution of the present invention. The feedback request 32 requests users to provide feedback on Web resources and links provided and to provide additional Web site suggestions. To provide feedback, the users can evaluate the linked sites, rate them on a one to five star scale, and return the rating to the Web site. The Web site can then use the evaluation ratings to order the links on the individual frames or to inform other users what sites have been found most useful. The e-mail list sign-up 33 invites users to subscribe to an e-mail list to receive up-to-date information. The e-mail link 34 provides a link for the user to send mail to the Web site. The start button 35 links the user to Plan of Attack frame 40 of FIG. 3.

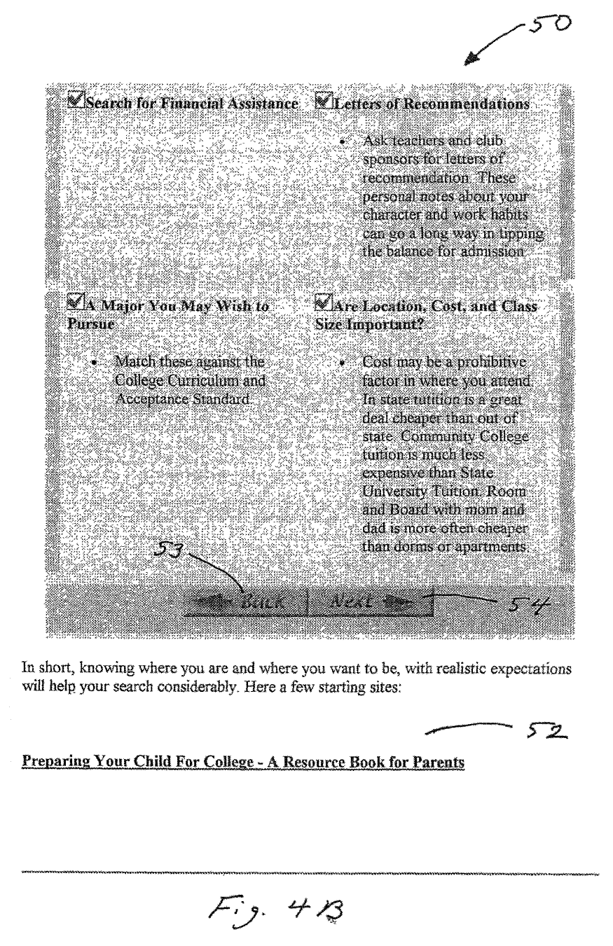

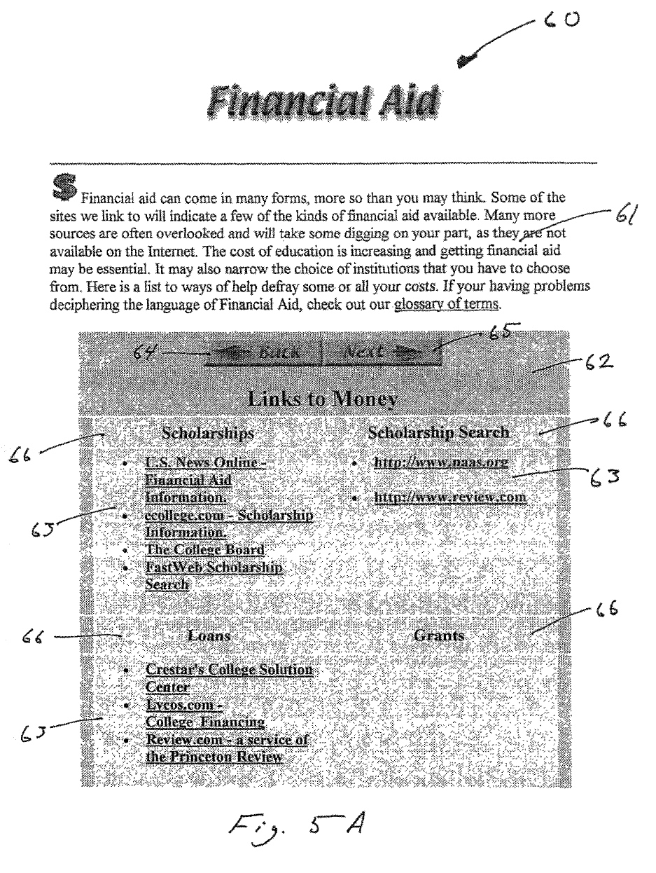

Plan of Attack frame 40 of FIG. 3 comprises college check list 41, Web links 42, back navigation buttons 43, and next navigation buttons 44. The college check list 41 outlines the steps of the post-secondary education planning system in checklist form and indicates the recommended order to complete the process. The Web links 42 provide related links to sites discussing post-secondary education planning generally. The back navigation buttons 43 link to the Home frame 30 of FIG. 2 and the next navigation buttons 44 link to Tips and Advice frame 50 of FIGS. 4A & 4B, providing an orderly step-through of the system.

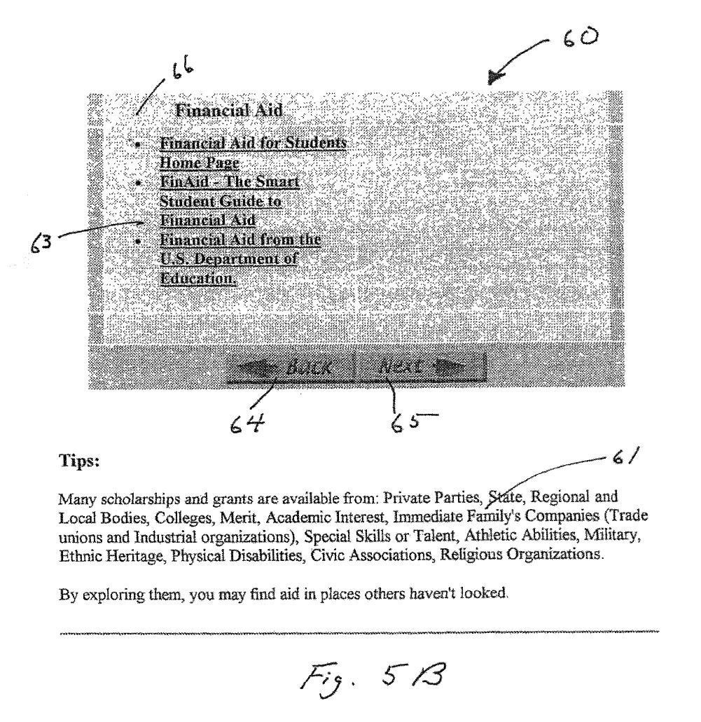

Tips and Advice frame 50 of FIGS. 4A & 4B comprises a general check list 51, Web links 52, back navigation buttons 53, and next navigation buttons 54. The general check list 51 provides general background tips and advice on elements that may be required as part of post-secondary education planning. The Web links 52 provide related links to sites discussing student readiness and goals for secondary education planning. The back navigation buttons 53 link to the Plan of Attack frame 40 of FIG. 3 and the next navigation buttons 54 link to Financial Aid frame 60 of FIGS. 5A & 5B, providing an orderly step-through of the system.

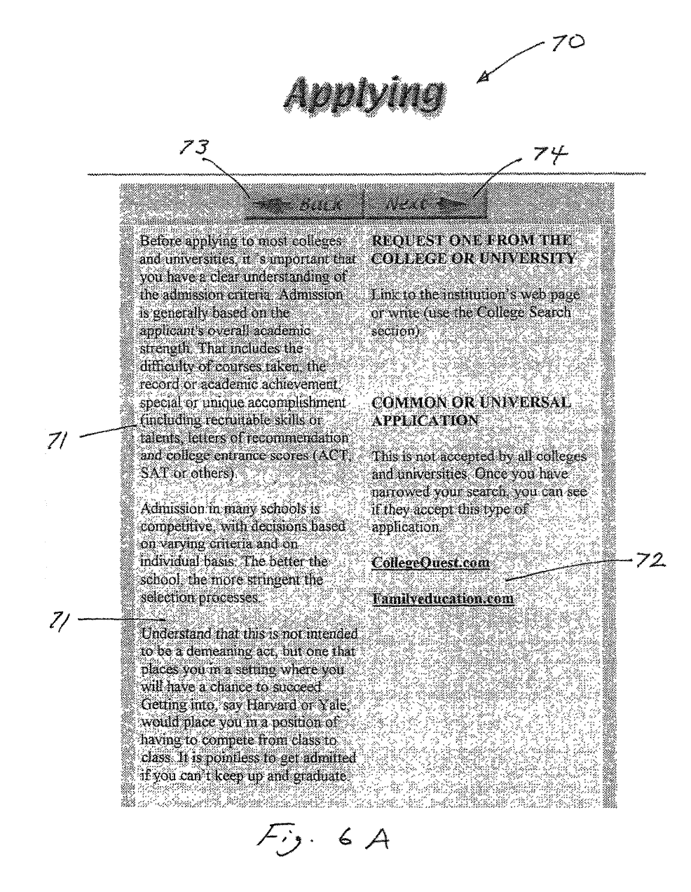

Financial Aid frame 60 of FIGS. 5A & 5B comprises financial aid advice 61, Web links section 62, topical subsections 66, Web links 63, back navigation buttons 64, and next navigation buttons 65. The financial aid advice 61 provides general advice on financial aid sources and availability. The Web links section 62 provides links to financial aid and advice, and is divided into topical subsections 66 for Scholarship, Scholarship Search, Loan, Grants, and Financial Aid. The Web links 63 provide links to sites discussing financial aid and advice, and are organized under the appropriate topical subsection 66 within the Web links section 62. The back navigation buttons 64 link to the Tips and Advice frame 50 of FIGS. 4A & 4B and the next navigation buttons 65 link to Applying frame 70 of FIGS. 6A & 6B, providing an orderly step-through of the system.

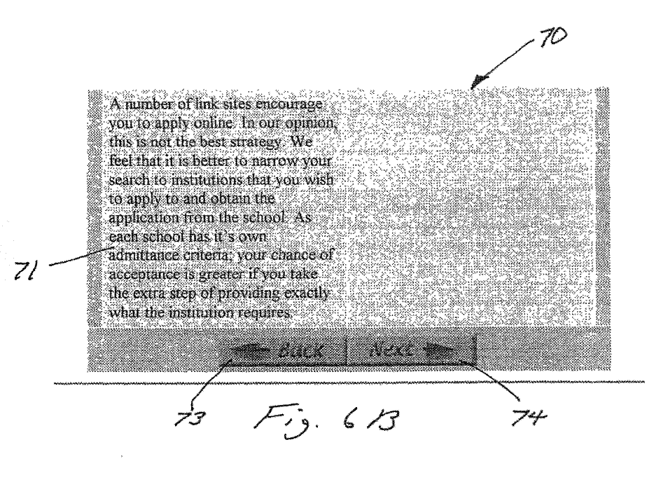

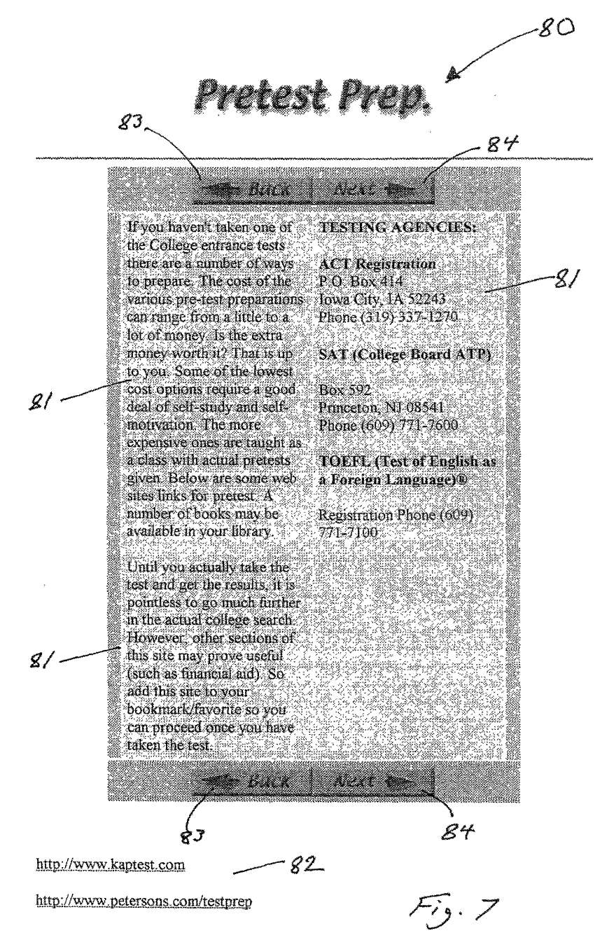

Applying frame 70 of FIGS. 6A & 6B comprises admission advice 71, Web links 72, back navigation buttons 73, and next navigation buttons 74. The admission advice 71 provides general advice on school applications and the application process. The Web links 72 provide links to sites discussing the applications process generally and specific school procedures. The back navigation buttons 73 link to the Financial Aid frame 60 of FIGS. 5A & 5B and the next navigation buttons 74 link to Pretest Prep. frame 80 of FIG. 7, providing an orderly step-through of the system.

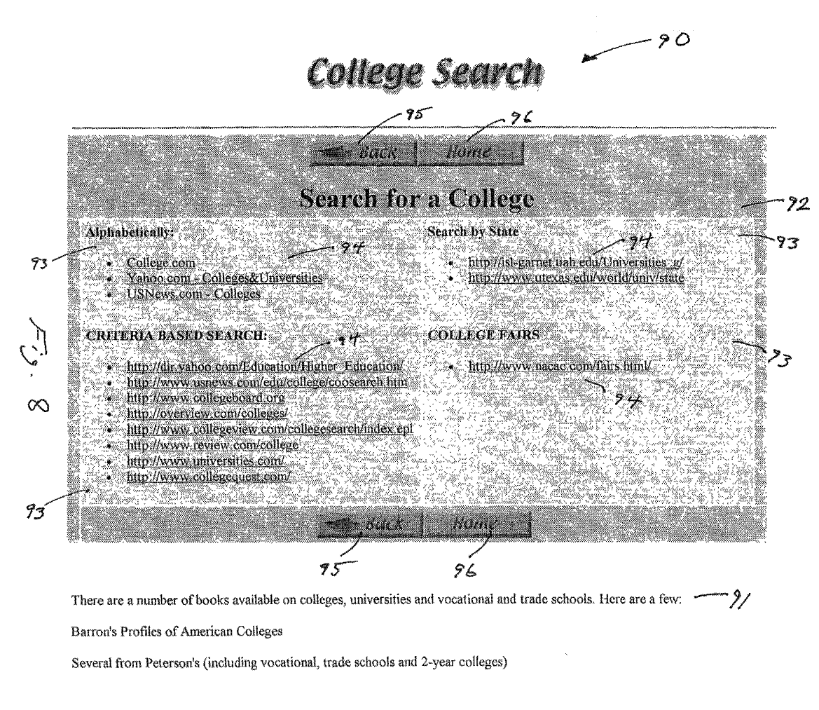

Pretest Prep. frame 80 of FIG. 7 comprises pre-test advice 81, Web links 82, back navigation buttons 83, and next navigation buttons 84. The pre-test advice 81 provides general advice on entrance tests and test preparation, and contacts for the major testing agencies. The Web links 82 provide links to sites discussing or providing pre-test preparation. The back navigation buttons 83 link to the Applying frame 70 of FIGS. 6A & 6B and the next navigation buttons 84 link to College Search frame 90 of FIG. 8, providing an orderly step-through of the system.

College Search frame 90 of FIG. 8 comprises college search advice 91, Web links section 92, topical subsections 93, Web links 94, back navigation buttons 95, and home navigation buttons 96. The college search advice 91 provides general advice on researching colleges and other institutions, including reference books available. The Web links section 92 provides links to school information, and is divided into topical subsections 93 for alphabetical listing, state listing, criteria based searches, and college fairs. The Web links 94 provide links to sites discussing colleges and college searching, and are organized under the appropriate topical subsection 93 within the Web links section 92. The back navigation buttons 95 link to the Pretest Prep. frame 80 of FIG. 7 and the home navigation buttons 96 link to the Home frame 30 of FIG. 2, providing an orderly step-through of the system.

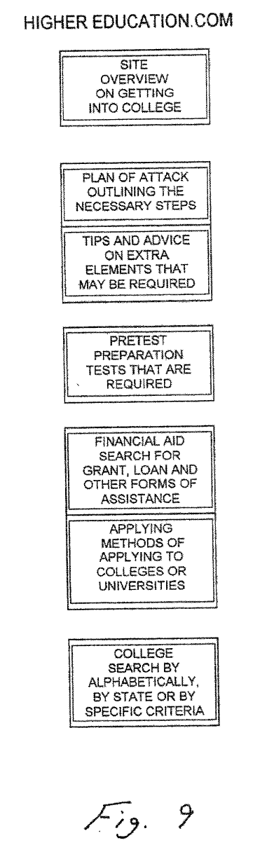

FIG. 9 illustrates the steps in taking a student from A to Z through the post-secondary education planning method of the present invention. The steps may be completed in different orders and certain steps may be skipped, depending on the needs of the user, but the present invention provides a method to consider all the necessary facets of post-secondary education planning. The electronic format on a global computer information network makes the system easily accessible to users of all backgrounds and organizes the available information to improve ease of use.

The above-described counseling method and system for post-secondary education planning using a global computer information network is intended to improve the education planning process, but is clearly suited for other uses. The method provides an orderly planning sequence to step through the planning process, reducing the struggle and expense of finding a college, university, adult education or trade school.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method for electronic post-secondary education planning over a computer network using an output device comprising:
providing subject frames, each of the subject frames having information on a topic of post-secondary education planning; and
providing navigation buttons, each of the navigation buttons linked to one of the subject frames;
wherein actuating one of the navigation buttons changes the subject frame displayed on the output device to the subject frame linked to the navigation button actuated.

2. The method of claim 1 further comprising presenting, in association with the subject frame displayed, the navigation button for a previous subject frame and the navigation button for a next subject frame.

3. The method of claim 1 further comprising presenting, in association with the subject frame displayed, Web links related to the topic of post-secondary education planning of the subject frame displayed.

4. The method of claim 3 further comprising:
accepting user ratings of the Web links;
compiling the user ratings; and
presenting, in association with the subject frame displayed, the compiled user ratings.

5. The method of claim 3 further comprising:
accepting user suggestions for additional Web links; and
presenting, in association with the subject frame displayed, the additional Web links.

6. The method of claim 1 further comprising:
providing a navigation frame; and
presenting, in association with the navigation frame, one or more of the navigation buttons.

7. The method of claim 1 wherein the topic of post-secondary education planning is selected from the group consisting of general information, planning considerations, planning goals, student readiness, tips and advice, documentation requirements, financial aid, financial aid searching, scholarship searching, loan searching, grant searching, application process, entrance tests, test preparation, college searching, vocational school searching, trade school searching, 2-year college searching, searching by state, and college fair searching.

8. A system for electronic post-secondary education planning over a computer network using a means for displaying information comprising:
means for providing subject frames, each of the subject frames having information on a topic of post-secondary education planning; and
means for navigating between frames, each of the frame navigating means linked to one of the subject frames;
wherein actuating one of the frame navigating means changes the subject frame displayed on the information display means to the subject frame linked to the frame navigating means actuated.

9. The system of claim 1 further comprising:
means for presenting, in association with the subject frame displayed, the frame navigating means for a previous subject frame and the frame navigating means for a next subject frame.

10. The system of claim 1 farther comprising:
means for presenting, in association with the subject frame displayed, Web links related to the topic of post-secondary education planning of the subject frame displayed.

11. The system of claim 3 further comprising:
means for accepting user ratings of the Web links;
means for compiling the user ratings; and
means for presenting, in association with the subject frame displayed, the compiled user ratings.

12. The system of claim 3 further comprising:
means for accepting user suggestions for additional Web links; and
means for presenting, in association with the subject frame displayed, the additional Web links.

13. The system of claim 1 further comprising:
means for providing a navigation frame; and
means for presenting, in association with the navigation frame, one or more of the frame navigating means.

14. The system of claim 1 wherein the topic of post-secondary education planning is selected from the group consisting of general information, planning considerations, planning goals, student readiness, tips and advice, documentation requirements, financial aid, financial aid searching, scholarship searching, loan searching, grant searching, application process, entrance tests, test preparation, college searching, vocational school searching, trade school searching, 2-year college searching, searching by state, and college fair searching.

15. A computer readable medium storing a computer program for electronic post-secondary education planning over a computer network using an output device comprising:
computer readable code for providing subject frames, each of the subject frames having information on a topic of post-secondary education planning; and
computer readable code for providing navigation buttons, each of the navigation buttons linked to one of the subject frames;
wherein actuating one of the navigation buttons changes the subject frame displayed on the output device to the subject frame linked to the navigation button actuated.

16. The computer readable medium of claim 8 further comprising:
computer readable code for presenting, in association with the subject frame displayed, the navigation button for a previous subject frame and the navigation button for a next subject frame.

17. The computer readable medium of claim 8 further comprising:
computer readable code for presenting, in association with the subject frame displayed, Web links related to the topic of post-secondary education planning of the subject frame displayed.

18. The computer readable medium of claim 10 further comprising:
computer readable code for accepting user ratings of the Web links;
computer readable code for compiling the user ratings; and
computer readable code for presenting, in association with the subject frame displayed, the compiled user ratings.

19. The computer readable medium of claim 10 further comprising:
computer readable code for accepting user suggestions for additional Web links; and
computer readable code for presenting, in association with the subject frame displayed, the additional Web links.

20. The computer readable medium of claim 8 further comprising:
computer readable code for providing a navigation frame; and
computer readable code for presenting, in association with the navigation frame, one or more of the navigation buttons.

21. The computer readable medium of claim 8 wherein the topic of post-secondary education planning is selected from the group consisting of general information, planning considerations, planning goals, student readiness, tips and advice, documentation requirements, financial aid, financial aid searching, scholarship searching, loan searching, grant searching, application process, entrance tests, test preparation, college searching, vocational school searching, trade school searching, 2-year college searching, searching by state, and college fair searching.
